(19) United States
(12) Patent Application Publication
(10) Pub. No.: US 2010/0305852 A1
(43) Pub. Date: Dec. 2, 2010

(54) DEVICE AND METHOD FOR AUTOMATIC ROUTE GENERATION OF A SPECIFIED DISTANCE

(76) Inventor: Nicola Louise Eger, South Yorkshire (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/472,757

(22) Filed: May 27, 2009

(51) Int. Cl. G01C 21/36

(52) U.S. Cl. 701/209; 701/207

(57) ABSTRACT

The disclosed systems and methods provide for automatic generation of a route of travel for a user. A user's starting location is determined based on location information received from a navigation system, such as a GPS navigation system. An input device receives an input of a specified distance the user intends to travel. If the user desires to travel a round trip back to the starting location, the system may generate a round-trip route of a distance substantially equaling the specified distance. Similarly, if the user desires to travel from a starting location to a different ending location, the system may generate a route between the two locations of a distance substantially equaling the specified distance. The system may output route information on a map-based display, provide audio turn-by-turn directions, and/or transmit route information to external devices.

### TECHNICAL FIELD OF THE INVENTION

The technology of the present disclosure relates generally to portable electronic devices, and more particularly to devices and methods by which a portable electronic device may automatically generate a travel route of a specified distance using GPS information.

### DESCRIPTION OF THE RELATED ART

Computer-based mapping tools provide a way for a user to generate a route of travel between two known points. For example, a user may input into a computer or like device a starting location and an ending destination. Based on the inputs, the mapping tool may generate a route of travel, typically the shortest or most convenient route based upon certain criteria. Information about the route, such as associated maps, specific direction instructions, distances, and the like also may be generated. A user may then print or otherwise output or store the information to use during travel. Some computer-based mapping tools also may permit a user to generate a customized route between the locations. Although adequate in many respects, such computer-based mapping tools may be inconvenient because of a lack of portability. A user must know the starting and ending destinations ahead of time to input the information into the computer.

Accordingly, more portable navigation tools have been developed. In general, portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera, an Internet browser for accessing news and information, an audiovisual media player, a messaging device (text, audio, and/or visual messages), a gaming device, a personal organizer, and have other functions as well.

Portable electronic devices also may include a portable navigation function. One commonly used navigation system for providing location information is the Global Positioning System, or GPS, initially developed for the United States military. GPS is now widely used around the world as a navigational tool for determining such location information as a user's three-dimensional location, speed of movement, direction of movement, and local time. Other regions and nations, such as the European Union, China, and India, are developing comparable location information systems. GPS or comparable navigations tools are now commonly incorporated into portable electronic devices, such as mobile telephones.

A GPS (or comparable) navigation device may accept inputs similarly to a computer-based mapping tool. For example, a user may input a starting location and an ending destination, and the GPS device may generate a route of travel. Portable GPS systems have advantages over the computer-based mapping tools because the portable systems may travel with the user. Portable GPS systems, therefore, may provide a user with real-time information as to the user's location, velocity, time of day, direction of travel, and the like. Portable GPS systems also may provide real-time turn-by-turn directions, whether displayed on small screen or “spoken” to the user. In addition, because a portable GPS system remains with the user, the user may enter new destinations or alter the destinations during travel. Furthermore, should a user stray from the established route, the system may generate a new route based on the user's current position.

Computer-based mapping tools and portable GPS systems typically are used by travelers to prevent getting lost. Sometimes, however, the starting and destination points may be the same, such as when a person travels round trip to and from a residence or other known location. Similarly, a user may know how to get from one location to another, and therefore does not require specific directions. Fitness enthusiasts in particular, such as runners, joggers, walkers, and cyclists, often begin and end their routes at the same location, or travel known routes between locations. For such individuals, getting lost is not typically a concern.

Fitness enthusiasts, however, are faced with a different issue—they often seek to travel a specified distance. Whether training for a specific competition, or simply attempting to attain personal fitness or health goals, such individuals desire to run, jog, walk, or cycle a specified distance. Conventional mapping tools may indicate a distance of a previously-indicated route, but cannot generate a round-trip route (or route between two known locations) of a specified distance. A similar deficiency is present in portable GPS and comparable navigation systems. Such systems may inform a user how to travel between two locations, but do not generate or adjust a route of travel, whether a round trip route or between locations, to meet specified distance criteria set by the user.

### SUMMARY

To improve the consumer experience with portable electronic devices, there is a need in the art for an improved system and methods for generating travel routes for a user. In particular, there is a need in the art for an improved automatic generation of a round-trip travel route for a single location, or of a travel route between known locations, based upon a specified distance.

In exemplary embodiments, a user's starting location is determined based on location information received from a navigation system, such as a GPS navigation system. The GPS information may correspond to the user's current location, or a location inputted by a user. An input device receives an input of a specified distance the user intends to travel. If the user desires to travel a round trip back to the starting location, the system may generate a round-trip route of a distance substantially equaling the specified distance. Similarly, if the user desires to travel from a starting location to a different ending location, the system may generate a route between the two locations of a distance substantially equaling the specified distance. The system may output route information on a map-based display, provide audio turn-by-turn directions, and/or transmit route information to external devices. In this manner, users, such as fitness enthusiasts, may obtain automatically generated routes of travel of a specified distance, which may aid the attainment of personalized health or fitness goals.

Therefore, according to one aspect of the invention, an electronic device includes a location data receiver for receiving location information from a navigation system, and an input device for receiving an input of a starting location of a user and an input of a specified distance. A controller is configured to generate a route of travel from the location information, wherein the route of travel begins at the starting location and the distance of the route of travel substantially equals the specified distance.

According to one embodiment of the electronic device, the controller is configured to generate a plurality of routes of travel, and the input device receives a selection of a route of travel from among the plurality of generated routes of travel.

According to one embodiment of the electronic device, the controller is configured to generate a route of travel that is a round trip route that ends at the starting location.

According to one embodiment of the electronic device, the input device receives an input of an ending location, and the controller is configured to generate a route of travel that begins at the starting location and ends at the ending location.

According to one embodiment of the electronic device, the input device receives an input of at least one intervening location between the starting location and the ending location, and the controller is configured to generate a route of travel that begins at the starting location, extends through any intervening locations, and ends at the ending location

According to one embodiment of the electronic device, the electronic device further includes an output device for outputting route information about the route of travel.

According to one embodiment of the electronic device, the output device is a display, and the route information includes a map-based display of the route information.

According to one embodiment of the electronic device, the route information further includes a display of at least one of a user location along the route, user speed, time of travel, distance of travel along the route, remaining portion of the route to be traveled, and calories.

According to one embodiment of the electronic device, the output device includes an audio output device, and the route information includes audio turn-by-turn directions for traveling along the route.

According to one embodiment of the electronic device, the route information further includes an audio indication of at least one of a user location along the route, user speed, time of travel, distance of travel along the route, remaining portion of the route to be traveled, and calories.

According to one embodiment of the electronic device, the electronic device further includes a memory for storing the route information, wherein the output device is a network interface for transmitting stored route information to another electronic device.

According to one embodiment of the electronic device, the electronic device is a mobile telephone.

According to another aspect of the invention, a method of generating a route of travel with an electronic device includes the steps of receiving location information from a navigation system, receiving an input of a starting location of a user and an input of a specified distance, and generating a route of travel from the location information, wherein the route of travel begins at the starting location and the distance of the route of travel substantially equals the specified distance.

According to one embodiment of the method, the generating step includes generating a plurality of routes of travel, and the method further includes receiving a selection of a route of travel from among the plurality of generated routes of travel.

According to one embodiment of the method, the generating step includes generating a route of travel that is a round trip route that ends at the starting location.

According to one embodiment of the method, the method further includes receiving an input of an ending location different from the starting location, and the generating step includes generating a route of travel that begins at the starting location and ends at the ending location.

According to one embodiment of the method, the method further includes receiving an input of at least one intervening location between the starting location and the ending location, and the generating step includes generating a route of travel that begins at the starting location, extends through any intervening locations, and ends at the ending location

According to one embodiment of the method, the method further includes displaying a map-based display of route information about the route.

According to one embodiment of the method, the method further includes outputting audio turn-by-turn directions for traveling along the route.

According to one embodiment of the method, the method further includes storing route information for the route of travel in a memory in the electronic device, and transmitting the stored route information to another electronic device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device for use in accordance with an embodiment of the present invention.

FIG. 2 is a schematic block diagram of operative portions of the mobile telephone of FIG. 1.

FIGS. 3-4 each depict an exemplary screenshot of features associated with embodiments of the route generation application of the present invention.

FIG. 5 is a flowchart depicting an overview of an exemplary method by which a route of a specified distance may be generated automatically.

FIGS. 6-9 each depict an exemplary screenshot of features associated with embodiments of the route generation application of the present invention.

FIG. 10 is a schematic diagram of a communications system in which the mobile telephone of FIG. 1 may operate.

### DETAILED DESCRIPTION OF EMBODIMENTS

Exemplary embodiments described herein provide for automatic generation of a route of travel for a user. A location data receiver receives location information from a navigation system, such as a GPS or other satellite-based navigation system. An input device receives an input of a starting location, which may be the user's current location or an alternative location inputted by the user, and a specified distance the user intends to travel. If the user desires to travel a round trip back to the starting location, a controller may generate from the location information a round-trip route of a distance substantially equaling the specified distance. Similarly, if the user desires to travel from the starting location to a different ending location, the controller may generate from the location information a linear route between the two locations of a distance substantially equaling the specified distance. The system may output route information to the user in a variety of ways. For example, route information may be provided on a map-based display, or as audio turn-by-turn directions. Route information also may be transmitted externally to other electronic devices, so users may share their routes. In this manner, users, such as fitness enthusiasts, may obtain automatically generated routes of travel of a specified distance, which may aid the attainment of personalized health or fitness goals.

Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate portable electronic device, examples of which include a media player, a gaming device, or a portable computer. For purposes of the description herein, the interchangeable terms “electronic equipment” and “electronic device” also may include portable radio communication equipment. The term “portable radio communication equipment,” which sometimes may be referred to as a “mobile radio terminal,” includes all equipment such as mobile telephones, pagers, communicators, electronic organizers, personal digital assistants (PDAs), smartphones, and any communication apparatus or the like.

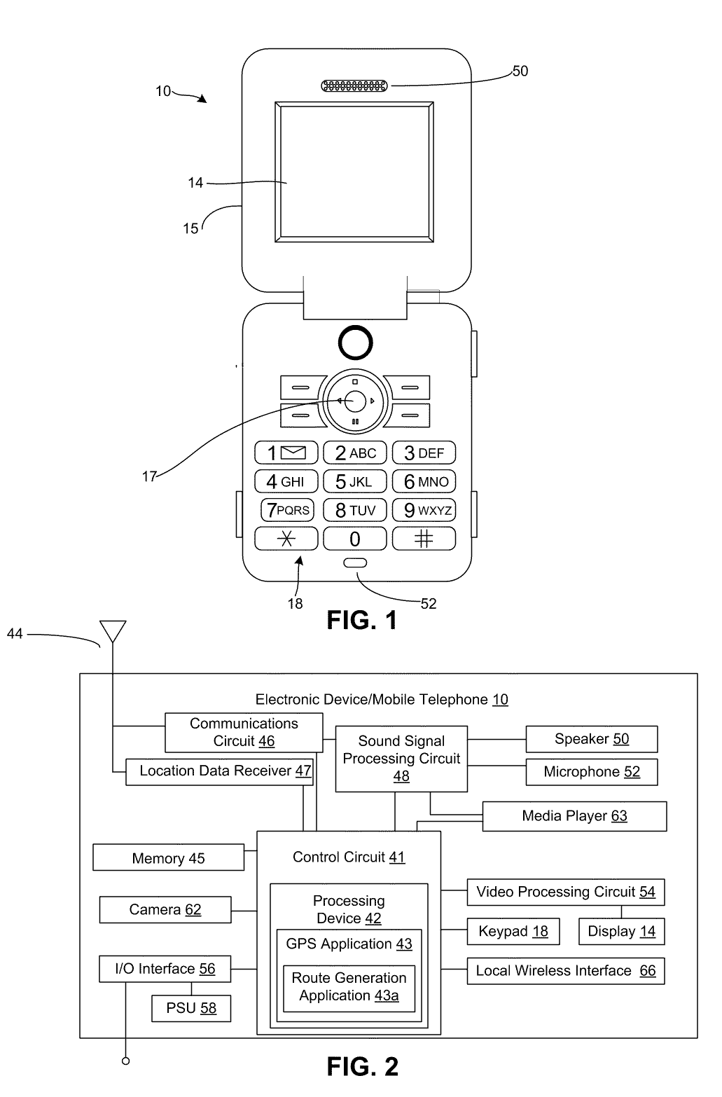

FIG. 1 depicts an exemplary mobile telephone 10. Mobile telephone 10 may be a clamshell phone with a flip-open cover 15 movable between an open and a closed position. In FIG. 1, the cover is shown in the open position. It will be appreciated that mobile telephone 10 may have other configurations, such as a “block” or “brick” configuration, or a swivel or slide cover configuration.

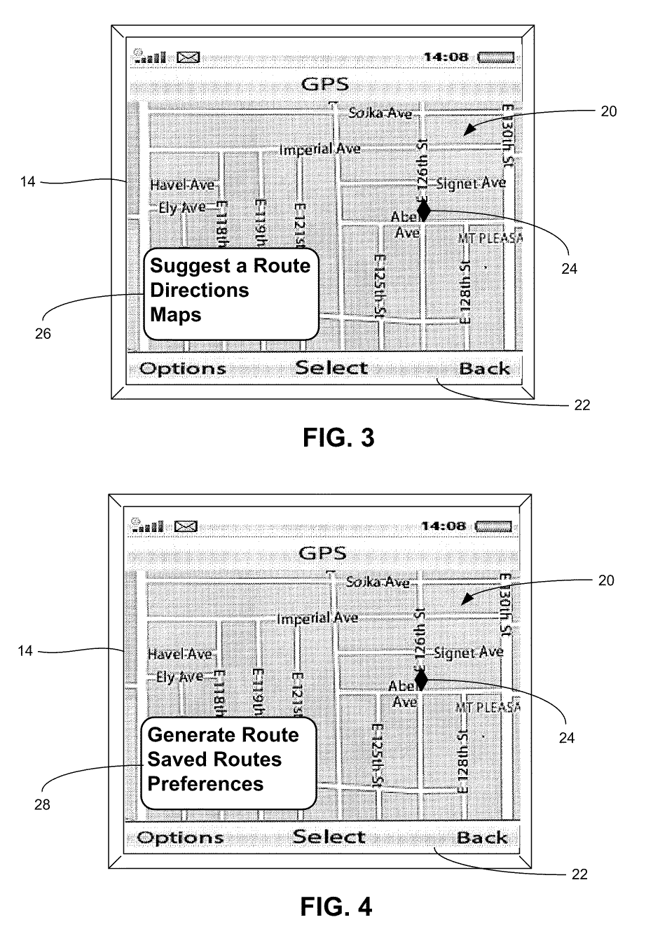

FIG. 2 represents a functional block diagram of operative portions of the mobile telephone 10. The mobile telephone 10 may include a primary control circuit 41 that is configured to carry out overall control of the functions and operations of the mobile telephone 10. The control circuit 41 may include a processing device 42, such as a CPU, microcontroller or microprocessor.

Among their functions, to implement the features of the present invention, the control circuit 41 and/or processing device 42 may comprise a controller that may execute program code stored on a machine-readable medium embodied as a GPS application 43. In accordance with the present invention, the GPS application 43 may further include a route generation application 43a. Applications 43 and 43a may be stand-alone software applications or form a part of a software application that carries out additional tasks related to the mobile telephone 10. In FIG. 2, route generation application 43a is depicted as being part of GPS application 43, but such need not be so. For example, route generation application 43a may be a distinct application from GPS application 43. Route generation application 43a also may be part of a different application, such as, for example, a dedicated fitness application for health and fitness training. Furthermore, although embodiments are described herein in connection with GPS systems, other comparable satellite-based location information systems may be employed.

It will be apparent to a person having ordinary skill in the art of computer programming, and specifically in application programming for mobile telephones, servers or other electronic devices, how to program a mobile telephone to operate and carry out logical functions associated with the GPS application 43 and route generation application 43a. Accordingly, details as to specific programming code have been left out for the sake of brevity. Also, while the code may be executed by control circuit 41 and/or processing device 42 in accordance with exemplary embodiments, such controller functionality could also be carried out via dedicated hardware, firmware, software, or combinations thereof, without departing from the scope of the invention.

The mobile telephone 10 may include an antenna 44 coupled to a communications circuit 46. The communications circuit 46 may include call circuitry that enables the mobile telephone 10 to establish a call and/or exchange signals with a called/calling device, typically another mobile telephone or landline telephone, or another electronic device. The communications circuit 46 also may be configured to transmit, receive, and/or process data such as text messages, often referred to as “SMS” (which stands for short message service) messages. The communications circuit 46 also may be configured to transmit, receive, and/or process electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in a memory 45, executing applications to allow user interaction with data, displaying video and/or image content associated with the data, outputting audio sounds associated with the data and so forth.

Mobile telephone 10 also includes a location data receiver 47 coupled to the antenna 44. The location data receiver may be a GPS receiver or a comparable receiver for use in a satellite-based navigation system. In FIG. 2, the communications circuit 46 and location data receiver 47 are depicted as sharing a common antenna 44. It will be appreciated that such a configuration is exemplary, and other configurations of these components may be employed. For example, each of the communications circuit and the location data receiver may be coupled to a distinct antenna. In addition, although these components are depicted as separate functional blocks, one or more of these functions may be incorporated into a common component. The location data/GPS receiver 47 receives satellite data, and optionally assistance data, as is conventional, which feeds into the GPS application 43. The GPS application 43 may convert the data from the location data/GPS receiver 47 into location information, which may be displayed or otherwise outputted by the mobile telephone.

Mobile telephone 10 has a display 14 viewable when the clamshell telephone is in the open position. Although not shown in the figures, additional displays may be contained on other faces of the device. Any such displays may be employed in embodiments of the present invention. The display 14 displays information to a user regarding the various features and operating state of the mobile telephone 10, and displays visual content received by the mobile telephone 10 and/or retrieved from a memory 45. Display 14 also may be used to display location and route information in accordance with embodiments of the present invention.

An input device is provided in the form of a keypad 18, which provides for a variety of user input operations. For example, keypad 18 typically includes alphanumeric keys for allowing entry of alphanumeric information such as telephone numbers, phone lists, contact information, notes, etc. In addition, keypad 18 typically includes special function keys 17 such as a “send” key for initiating or answering a call, and others. The special function keys 17 may also include various keys for navigation and selection operations to access menu information within the mobile telephone 10. As shown in FIG. 1, for example, the special function keys may include a five-way navigational ring containing four directional surfaces and a center button that may be used as an “enter key” selection button. Some or all of the keys may be used in conjunction with the display as soft keys. Keys or key-like functionality also may be embodied as a touch screen associated with the display 14.

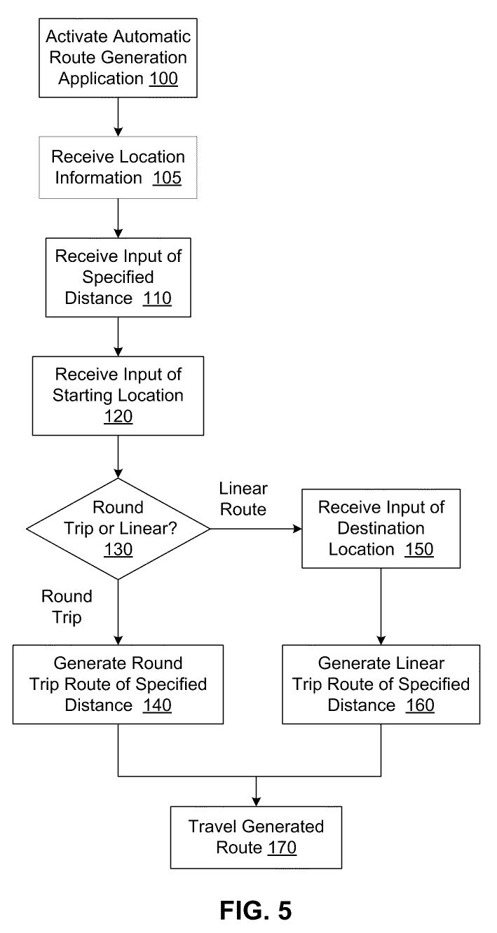

FIG. 3 depicts an exemplary screenshot that may be displayed on display 14. This particular screen may be associated with the GPS application 43, which may be selected from within the mobile telephone using a menu system, a dedicated key button, or by any other conventional means. In this particular example, the GPS application generates a graphical user interface in the form of a map 20 and menu bar 22 for selecting exemplary menu and input options. In this example, the map 20 includes a map of the area in the vicinity of a user, as well as a position indicator 24 that indicates the user's precise position relative to the map. It will be appreciated that the form and content of the GPS information depicted in FIG. 3 is an example and may be varied.

In this example, GPS application 43 also may generate a GPS menu 26 that contains various options relating to the GPS application. For example, a user may select to obtain travel directions as is common in using portable GPS systems. A user also may access various maps that may have been stored by the GPS application. An option may be selected from the menu 26 by using the menu bar 22 or by other conventional means. As above, the form and content of the GPS menu 26 is but an example and may be varied. In this example, a user also has the option to select a “Suggest a Route” function, which will be described in more detail below. By selecting the “Suggest a Route” function, a user may cause the controller of the mobile telephone to execute the route generation application 43a. It is presumed herein that a user selects the “Suggest a Route” function.

FIG. 4 depicts an exemplary screenshot that may be displayed on display 14 when a user selects to execute the route generation application 43a. FIG. 4 is similar to FIG. 3, except that an exemplary route generation menu 28 is displayed. As above, the form and content of the route generation menu 28 is but an example and may be varied. In this example, the user is afforded options relating to route generation such as “Generate Route”, “Saved Routes”, and “Preferences”, all of which will be described in more detail below. In a first example, it is presumed that the user selects the “Generate Route” function.

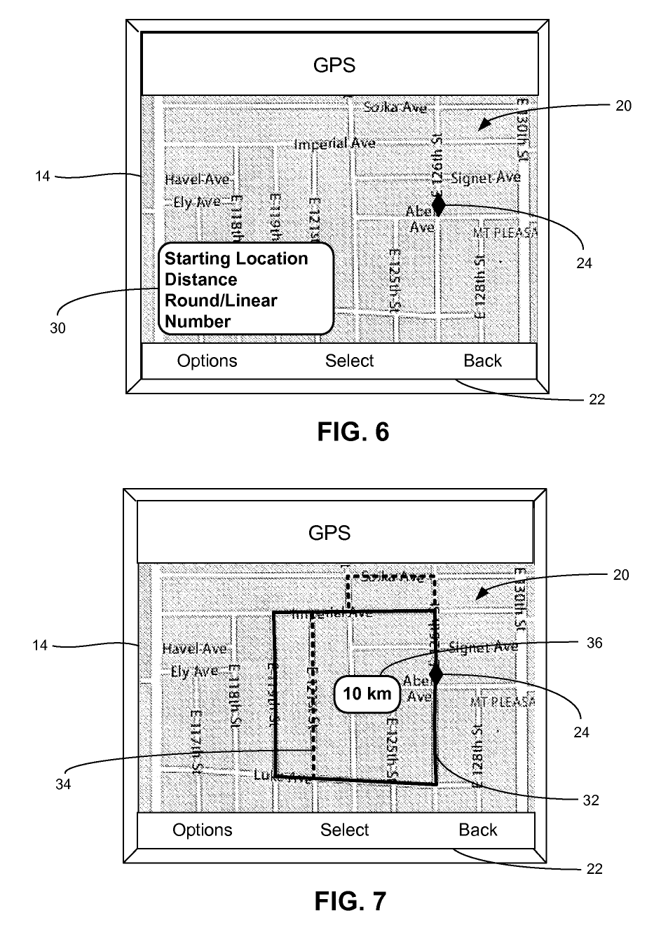

FIG. 5 is a flow chart depicting an overview of an exemplary method by which a route of a specified distance may be generated automatically in accordance with embodiments of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 100 at which the electronic device receives a user input to activate the automatic route generation application, such as application 43a. At step 105, the electronic device may receive location information, such as GPS information provided by a GPS or other location data receiver. At step 110, the electronic device may receive a user input of a specified distance over which the user desires to travel. At step 120, the electronic device may receive a user input of a starting location for the route. At step 130, the electronic device may receive a user selection of either traveling a round trip route, for which the destination location is the same as the starting location, or a linear route between two different locations.

If a round trip is selected, then at step 140 the route generation application may automatically generate from the location information a round trip route equaling or substantially equaling the specified distance. If a linear route is selected, then at step 150 the electronic device may receive a user input of an ending or destination location. At step 160, the route generation application may automatically generate from the location information a linear route between the starting and destination locations equaling or substantially equaling the specified distance. Regardless of the type of route, at step 170 the user may travel the generated route. As stated above, FIG. 5 represents an overview, and additional details for automatic route generation are described with respect to the following examples.

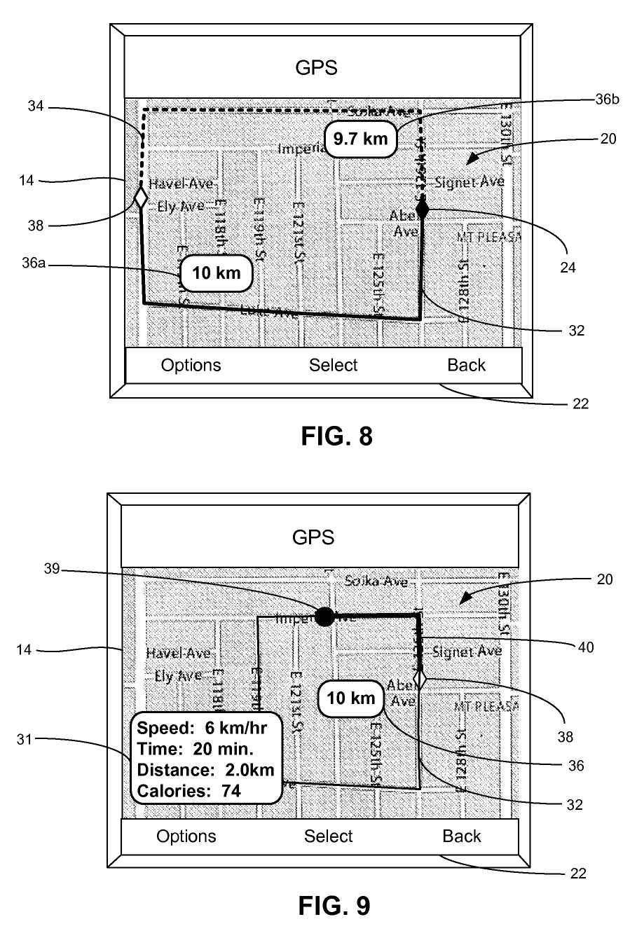

FIGS. 6-9 depict various ways by which a user may employ the “Generate Route” function of FIG. 4 to generate a customized route. It will be appreciated that the following discussion provides examples for illustrative purposes, and, as before, the precise form and content of the maps, graphical display, and menus may be varied.

FIG. 6 depicts an exemplary screenshot that may be displayed on display 14 when a user selects to generate a route in accordance with embodiments of the invention. FIG. 6 includes a route generation menu 30 that provides a user with various options for automatically generating a travel route. Selections from the route generation menu 30 may be made by a variety of means. For example, a selection from the route generation menu 30 may result in the display of additional submenus or associated drop-down menus. Alternatively, a selection from the route generation menu 30 may result in the display of text box in which the user may enter character-based inputs using the keypad 18 of the mobile telephone. Other conventional input mechanisms may be employed.

As depicted in the route generation menu 30, a first exemplary parameter option for the user may be the starting location. It will be appreciated that the indicator 24 may more broadly be referred to as a starting location indicator. The user may select that the starting location be the same as the user's current location. The user alternatively may select that the starting location be a location inputted by the user which differs from the current location. The starting location may be selected by the user regardless of whether the user is to travel a round trip or linear trip. Indicator 24, therefore, provides an indication of an input of a starting location, whether such location corresponds to the GPS information for the user's current location, or whether the starting location corresponds to GPS information for an inputted location different from the current location. In one embodiment, the user's current location may be the default starting location.

As also depicted in the route generation menu 30, a second exemplary parameter option for the user may be the specified distance the user wishes to travel. For example, a user may be a runner who desires to run 10 km for training or fitness purposes. A user may specify any distance by one of the input mechanisms described above. A third exemplary parameter option may be whether the user desires a round trip, or a linear trip between two different locations. As stated above, if a user desires a round trip, the user may optionally choose the current location as the starting location, or may input some other location. Similarly, if the user selects a linear trip, the user may input a starting location, which may or may not be the current location, and a destination location. In one embodiment, a user also may have the option to input one or more intervening locations, either partially through a round trip or between two end locations in a linear trip. The generated route would then extend through any intervening locations. As an exemplary fourth parameter option, a user may select a number of a plurality of alternative routes to generate, from which the user may select one of the plurality of routes as the travel route.

In addition to the input mechanisms described above, a touch screen input optionally may be suitable for map-based inputs. For example, display 14 may include a touch screen surface for receiving such inputs. A user may select a map location by tapping the location on the screen with a finger, stylus, or comparable input instrument. Such a map-based input may be employed to select a starting location. Such an input also may be employed to select one of a plurality of routes depicted onscreen. In addition, as is common in conventional GPS or mapping tools, the user may provide navigation inputs to alter or move the map region being displayed.

FIG. 7 depicts an exemplary screenshot for an example in which, from the previous route generation menu 30, the user has specified a distance of 10 km, selected a round trip, and specified the generation of two alternative routes. From the received GPS location information and user inputs, the route generation application generates two alternative routes of travel round trip to and from the starting location. As seen in FIG. 7, a first route indicator 32 indicates one alternative route with a solid line path, and a second route indicator 34 indicates a second alternative route with a dashed line path. A distance indicator 36 also may be displayed. In this example, the user has selected a common distance of 10 km for the alternative routes, and the routes happen to overlap substantially. In alternative embodiments, a user may select to generate routes of differing distances, and/or the routes may overlap to other degrees or not at all. Had intervening locations been inputted, each route alternative would have been generated to pass through any intervening locations. A user may select one of the alternative routes by one of the various input mechanisms described above. A user also may have the option to decline all generated routes and have new routes generated. A user also may have the option to edit the routes, such as by including or avoid specific streets or locations along the route. It will also be appreciated that depending upon the actual street layout, it may be difficult to generate a route of the exact distance specified. In such a case, the generated route is as near as practicable and substantially equal to the inputted specified distance, and the actual distance of a generated route may also be displayed to the user.

FIG. 8 depicts an exemplary screenshot for an example in which a user has again specified a distance of 10 km and the generation of two alternative routes, but in this example the user has selected to travel a linear route between two locations. From the received GPS location information and user inputs, the route generation application generates two alternative routes of travel from the starting location (whether current or inputted) to an ending location. Similar to FIG. 7, in FIG. 8 a first route indicator 32 again indicates one alternative route with a solid line path, and a second route indicator 34 again indicates a second alternative route with a dashed line path. In this case, the routes span from the starting location indicator 24 to a destination indicator 38. Again, had intervening locations been inputted, each route alternative would have been generated to pass through any intervening locations. In this example, there are two distance indicators 36a and 36b which indicate that the first route is 10 km and the second route is 9.7 km respectively. In other words, because of the actual street layout, the second route was determined as near as practicable and substantially equal to the inputted specified distance of 10 km.

It will, therefore, be appreciated that by modifying the selected locations and input parameters, such as the starting location, specified distance, type of trip (round vs. linear), intervening locations, number of a plurality of routes to generate, ending location, and/or other parameters, a user may employ route generation application 43a to automatically generate a variety of routes among and between various locations.

FIG. 9 depicts an exemplary screenshot for an example in which a user has selected to travel the first route identified in FIG. 7 by first route indicator 32. In this example, an output device for outputting route information is provided as display 14. The user has begun to travel the route by running, walking, jogging, cycling, or by some other means. It will be appreciated that once the user begins moving, it may no longer be convenient for the clamshell telephone to be in the open position, insofar as the keypad 18 may no longer be needed for inputs. Display 14, therefore, may be an external display viewable when the clamshell is in the closed position, which may be more convenient to view when the user is in motion.

As in previous figures, in FIG. 9 the first route indicator 32 indicates the entire route. In addition, because this example constitutes a round trip, the destination indicator 38 is located at the starting location. A route traveled indicator 40 may indicate a portion of the route that the user already has traveled. The route traveled indicator 40 may be darkened relative to the route indicator 32 so as to distinguish the traveled portion of the route from the non-traveled portion of the route. FIG. 9 also depicts a route location indicator 39 that indicates, based on received GPS location information, the user's actual location on the map while the user is traveling the route. A comparable map-based display may be provided for any generated route that a user has selected for travel.

FIG. 9 also depicts an exemplary route information box 31. The route information box 31 provides the user with a variety of information items regarding the route, such as the user's speed, time the user has traveled along the route, and the distance the user has traveled along the route. In addition, in anticipation that the present invention may be used by fitness or health enthusiasts, a calories indicator informs the user of the number of calories burned thus far in traveling the route. Other GPS-related information may be displayed, such as heading direction, time, altitude, and others. It thus will be appreciated that the route information box 31 is an example, and its form and content may be varied.

Referring again to FIG. 4, additional features of the route generation application will now be described. FIG. 4 depicts a “Saved Routes” option in the route generation menu 28. Once the route generation application has generated a route, the user may be afforded an option to save the generated route for future use. Accordingly, a user may select to travel a previously generated and saved route, rather than generating a new route. Saved routes may be stored, for example, in a memory 45 (see FIG. 2) of the mobile telephone. In one embodiment, route information also may be saved. For example, the system may generate and save journey statistics such as time, calories, average speed, and others. In this vein, the system may also generate and store personal bests statistics so that a user may track progress toward attaining health and fitness goals.

FIG. 4 also depicts a “Preferences” item in the routes generation menu 28 for accessing additional features, which may be varied. As one set of preferences, a user may edit saved or suggested routes. For example, as stated above, a user may input intervening locations, which may suggest stops or milestones within a route. A user also may input other route edits or preferences, such as preferences to travel certain streets, roads and paths, and/or avoid others that may be busy or dangerous. Route preferences may be based on local time. For example, during daylight a user may have a preference for wooded or other scenic or secluded routes, while the user may prefer more habited or populous routes during nighttime. Various other route edits or preferences may be employed. Such edits or preferences may be applied to previously saved routes, or there may be an option to edit a suggested route at the time the suggested route is first generated. Such preferences also may be generalized so that they are accounted for at the outset when any route is generated.

Other options within the Preferences item may provide access to varying output features associated with the display of route information. In one embodiment, a user may select to designate an audio output device, such as a speaker or headphone interface, for outputting route information additionally or alternatively to the visual display depicted in FIG. 9. Runners, joggers, walkers, and the like may find it difficult because of their motion to view the display frequently. An audio output may be provided, including turn-by-turn directions so the user does not have to view the display to maintain the route. The audio output also may include periodic updating to the route information, such as, for example, periodically updated route information contained in the route information box 31 of FIG. 9. Should the user be listening to music or other audio, as is common for fitness enthusiasts, the audio outputs of the route generation application may be provided as a periodic interrupt to the other audio. For example, an interrupt may be a total interrupt by which the other audio is silenced while route information is provided, or a partial interrupt by which the volume of the other audio is partially reduced so the user can adequately hear the audio output of the route information.

Another output option may be the capability to share previously saved routes with others. For example, previously saved routes may be stored in a removable storage device, such as an SD or other memory card. The removable storage device may then be shared with others. An output device also may be provided in the form of a network interface, by which saved routes may be transmitted between or among devices over a wired or wireless interface as are known in the art.

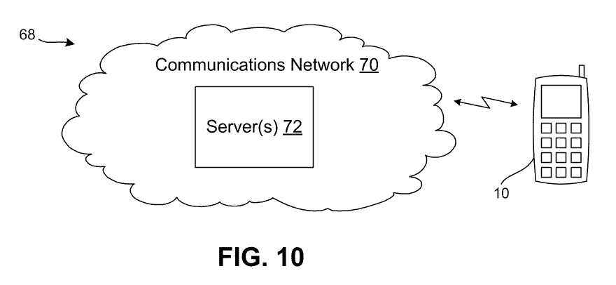

In this vein, referring to FIG. 10, the mobile telephone 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software. The network 70 may be employed by numerous users to transmit and share previously generated routes between and among participant devices.

Referring again to FIGS. 1 and 2, additional features of the mobile telephone 10 will now be described. For the sake of brevity, generally conventional features of the mobile telephone 10 will not be described in great detail herein.

The display 14 may be coupled to the control circuit 41 by a video processing circuit 54 that converts video data to a video signal used to drive the display. The video processing circuit 54 may include any appropriate buffers, decoders, video data processors and so forth. The video data may be generated by the control circuit 41, retrieved from a video file that is stored in the memory 45, derived from an incoming video data stream received by the communication circuit 46, or obtained by any other suitable method. A media player 63 within the mobile telephone may be used to play audiovisual files stored in memory or streamed over a network. Additional features, such as a camera 62, may also be present in the mobile telephone 10.

The mobile telephone 10 further includes a sound signal processing circuit 48 for processing audio signals transmitted by and received from the communications circuit 46. Coupled to the sound processing circuit 48 are a speaker 50 and microphone 52 that enable a user to listen and speak via the mobile telephone 10 as is conventional. The sound signal processing circuit 48 may also process the audio outputs associated with the route generation application as described above, which in one embodiment may be outputted through the speaker 50. The microphone 52 also may be employed as an input device for inputting voice commands, and may be used in particular to provide inputs associated with the present invention as voice commands.

The mobile telephone 10 also may include a local wireless interface 66, such as an infrared transceiver and/or an RF adaptor (e.g., a Bluetooth adapter), for establishing communication with an accessory, another mobile radio terminal, a computer or another device. For example, the wireless interface may be employed to communicate with wireless headphones for providing audio outputs of route information.

The mobile telephone 10 also may include an I/O interface 56 that permits connection to a variety of conventional I/O devices. One such device is a power charger that can be used to charge an internal power supply unit (PSU) 58. The I/O interface 56 also may be employed to provide wired outputs of route information. For example, the I/O interface 56 may provide an output of audio route information to wired headphones, or provide a wired transmission of route information to an external network or another electronic device.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. An electronic device comprising:
a location data receiver for receiving location information from a navigation system;
an input device for receiving an input of a starting location of a user and an input of a specified distance; and
a controller configured to generate a route of travel from the location information, wherein the route of travel begins at the starting location and the distance of the route of travel substantially equals the specified distance.

2. The electronic device of claim 1, wherein the controller is configured to generate a plurality of routes of travel, and the input device receives a selection of a route of travel from among the plurality of generated routes of travel.

3. The electronic device of claim 1, wherein the controller is configured to generate a route of travel that is a round trip route that ends at the starting location.

4. The electronic device of claim 1, wherein the input device receives an input of an ending location, and the controller is configured to generate a route of travel that begins at the starting location and ends at the ending location.

5. The electronic device of claim 4, wherein the input device receives an input of at least one intervening location between the starting location and the ending location, and the controller is configured to generate a route of travel that begins at the starting location, extends through any intervening locations, and ends at the ending location

6. The electronic device of claim 1, further comprising an output device for outputting route information about the route of travel.

7. The electronic device of claim 6, wherein the output device is a display, and the route information comprises a map-based display of the route information.

8. The electronic device of claim 7, wherein the route information further comprises a display of at least one of a user location along the route, user speed, time of travel, distance of travel along the route, remaining portion of the route to be traveled, and calories.

9. The electronic device of claim 6, wherein the output device comprises an audio output device, and the route information comprises audio turn-by-turn directions for traveling along the route.

10. The electronic device of claim 9, wherein the wherein the route information further comprises an audio indication of at least one of a user location along the route, user speed, time of travel, distance of travel along the route, remaining portion of the route to be traveled, and calories.

11. The electronic device of claim 6, further comprising a memory for storing the route information, wherein the output device is a network interface for transmitting stored route information to another electronic device.

12. The electronic device of claim 1, wherein the electronic device is a mobile telephone.

13. A method of generating a route of travel with an electronic device comprising the steps of:
receiving location information from a navigation system;
receiving an input of a starting location of a user and an input of a specified distance; and
generating a route of travel from the location information, wherein the route of travel begins at the starting location and the distance of the route of travel substantially equals the specified distance.

14. The method of claim 13, wherein the generating step comprises generating a plurality of routes of travel, and the method further comprises receiving a selection of a route of travel from among the plurality of generated routes of travel.

15. The method of claim 13, wherein the generating step comprises generating a route of travel that is a round trip route that ends at the starting location.

16. The method of claim 13, further comprising receiving an input of an ending location different from the starting location, and the generating step comprises generating a route of travel that begins at the starting location and ends at the ending location.

17. The method of claim 16, further comprising receiving an input of at least one intervening location between the starting location and the ending location, and the generating step comprises generating a route of travel that begins at the starting location, extends through any intervening locations, and ends at the ending location

18. The method of claim 13, further comprising displaying a map-based display of route information about the route.

19. The method of claim 13, further comprising outputting audio turn-by-turn directions for traveling along the route.

20. The method of claim 13, further comprising:
storing route information for the route of travel in a memory in the electronic device; and
transmitting the stored route information to another electronic device.
